(19) United States
(12) Patent Application Publication
(10) Pub. No.: US 2010/0059502 A1
(43) Pub. Date: Mar. 11, 2010

(54) CONTROL OF HEATING CABLE

(75) Inventor: Jason Daniel Harold O'Connor, Derbyshire (GB)

Correspondence Address: MICHAEL BEST & FRIEDRICH LLP, 100 E WISCONSIN AVENUE, Suite 3300, MILWAUKEE, WI, 53202, US

(73) Assignee: HEAT TRACE LIMITED, Frodsham (GB)

(21) Appl. No.: 11/722,474

(22) PCT Filed: Dec. 22, 2005
(86) PCT No.: PCT/GB05/05035

§ 371 Date: Jun. 21, 2007

(30) Foreign Application Priority Data
Dec. 24, 2004 (GB) 0428297.6

(51) Int. Cl. H05B 3/56

(52) U.S. Cl. 219/505

(57) ABSTRACT

Devices and methods for the control of heating cables are described. A first heating cable assembly includes a heating cable, a heater regulator for connection electrically in series between the heating cable and a voltage source. The heater regulator comprises a material having a positive temperature coefficient of resistance such that in use the voltage across the heating cable is dependent upon the temperature of the heater regulator. A second heating cable assembly includes a heating cable having a resistive heating element, a material having a positive temperature coefficient resistance for controlling the heat output from the heating cable, and a cold start limiter element comprising a material having a negative temperature coefficient of resistance for connection electrically in series with the heating element and a voltage source.

The present invention relates to methods and apparatus for the temperature dependent control of a heating cable. Particular aspects of the invention are suitable for, but not limited to, controlling the supply of heat to a heated conduit, such that fluid flowing within the conduit is heated.

It is a common requirement to control the supply of power to a heater. The supply of power may be determined by the temperature of the ambient environment, the temperature of the heater itself or the temperature of an object being heated. For pipelines that involve exposure to the outside environment, it is commonly advantageous to supply the pipeline with a heater, to prevent the fluid flowing within the pipe freezing during cold periods. If the fluid, such as water, freezes this may cause serious damage to the pipeline.

A known solution to this problem is to supply the pipeline in the form of a heated conduit. A heating cable is disposed along the length of a fluid conduit. The whole ensemble is surrounded by thermal insulation. The heating cable is connected to an electricity supply, which when turned on causes the heating cable to heat up, thus transferring heat to the conduit and ultimately to the fluid flowing within the conduit. Examples of this type of heated conduit are described within International Patent Application No. PCT/GB2003/003350. The heated conduit must be able to supply enough heat to prevent the fluid from freezing at the minimum expected temperature. At all other times more heat will be supplied to the heating conduit than is strictly needed. This is an inefficient use of electricity, and consequently expensive.

Self-limiting electrical heaters are known, in which a resistor is elongate and extends along the length of the heating element so as to be responsive to the temperature of the entire length of the heating element. Such a heater is described within WO 86/01064. The heating element and resistor are connected in series, with the resistor having a positive temperature coefficient such that its electrical resistance is substantially less than that of the heating element when at a normal operating temperature, but increases rapidly when exposed to temperatures above the normal operating temperature. Although such a resistor is suitable for ensuring that the temperature of the heating element does not significantly increase above the normal operating temperature, it is not suitable for acting as a heated regulator for applications such as pipe freezing. In such applications, it is important that at least one of the ambient air temperature and the temperature of the fluid are monitored, so as to prevent freezing of the fluid.

Therefore, such a heated conduit will normally be connected to some form of control device to maintain the temperature of the conduit at a constant temperature. Typically, the control of the supply of electrical energy to the heated conduit is via a thermostat. Thermostats work by having a temperature set point. The heater is switched on when the temperature falls to a predetermined level below the set point. The heater is switched off when the temperature rises to a predetermined level above the set point. The temperature difference between the on and off switching points is known as the “switching differential”. When the temperature at the thermostat is between the switch points the full amount of electrical energy is being supplied to the heater.

As the level of the switch ‘on’ point is typically not much below the level of the set point it is not strictly necessary to supply the heater with the full amount of electrical energy. This may be regarded as wasted energy. Further, the effect of switching on, and later off, causes the heater to continually form a heating and cooling cycle. This causes continual expansion and contraction of the heater, and the fluid conduit. This continual expansion of contraction may eventually lead to heater failure, or damage to the object being heated. Further the switching itself is likely to be at a high current and voltage. This could cause a high-energy spark. This could compromise safety, particularly when the equipment is located in a potentially hazardous industrial setting or area.

The problem of wasted energy may be exacerbated by the location of the temperature sensor of the thermostat. For heated conduits designed to prevent the fluid from freezing during winter the sensor is usually located to sense the ambient air temperature. Typically, this is designed to switch on the heated conduit when the air temperature falls to, for example, 3 degrees Celsius. However, the designed minimum temperature, for which the heated conduit will prevent the pipeline from freezing, is typically tens of degrees lower than this value. This is to ensure that the equipment can cope with the worst possible winter conditions expected. Empirical evidence has shown that the energy wastage may be as much as 90%, as the ambient temperature rarely, if ever, reaches the designed minimum temperature.

However, the alternative of locating the temperature sensor on the fluid conduit itself is not without problems. The temperature sensor can only sense the temperature at that position. Elsewhere along the fluid conduit other conditions may prevail. This may lead to the heated conduit being turned off at too low a temperature, causing damage to another part of the pipeline. Clearly, air sensing poses the least risk of damage to the conduit, but is massively inefficient. Sensing the temperature of the conduit offers greater energy efficiency, however there is greater risk of damage to the fluid conduit.

An improvement suitable for when the temperature sensor of the thermostat is located to sense the ambient temperature is described in UK Patent GB2156098. An electronic device operates by calculating a relationship between the percentage of the time during which electrical power is supplied to the heated conduit, and the ambient air temperature. At the minimum ambient air temperature, electrical power is supplied to the heated conduit 100% of the time. As the ambient temperature approaches the desired temperature of the heated conduit, a rapid on-off cycle for the heater is established. The duty cycle between on and off will be proportional to the temperature difference between the minimum ambient temperature and the desired temperature of the heated conduit.

The frequency of cycling will normally be high, typically switching several times per second. However, switching cycles of up to one hour are possible. With such rapid switching the power may be thought of as being supplied to the heated conduits in a relatively smoothed manner. The worst effects of the expansion and contraction of the heated conduits are minimised, as there is a reduced time span in which to expand or contract.

Similarly, wasted energy is almost eliminated. However, this technology does still involve switching on and off the heater, albeit rapidly. Most importantly, this form of control of heated conduits requires a relatively complex electronic circuit. Consequently it is an expensive solution. This is undesirable, as heated conduits are typically low cost items.

When a device with a material having a conductive positive temperature coefficient of resistance is switched on (known as a cold start), the initial current that is generated is high and over a short time period (a few minutes) this will fall very quickly to a stable operating current. The initial current is known as the in-rush current and can be many orders of magnitude higher than the stable operating current. Such high in-rush current phenomena result in costs that are higher than those required for the stable operating current. Cables and switchgear must be sized for the high start up current rather than the lower operating current. The in-rush current means that a larger number of circuits are required compared to those required for the stable operating current. In addition there is a major safety issue. The large in-rush current means that it is not practical to adequately fuse protect the circuits.

If this in-rush current could be eliminated then there would be very significant savings in capital and operational costs. It is an aim of embodiments of the present invention to obviate, or mitigate, at least one of the above-identified problems. Specifically, it is an aim of embodiments of the present invention to provide a relatively cheap temperature dependent heating device.

According to a first aspect of the present invention there is provided a heating cable assembly comprising: a heating cable; a heater regulator for connection electrically in series between the heating cable and a voltage source; wherein the heater regulator comprises a material having a positive temperature coefficient of resistance such that in use the voltage across the heating cable is dependent upon the temperature of the heater regulator.

As such a device provides a continuous control of the power supplied to the heater, there is no continuous on and off switching of the power (i.e. it provides “switchless” temperature control). Consequently, there is a reduced risk of high-energy sparks. Additionally, there is a reduction in the expansion and contraction cycle of both the heating and the device being heated. The life expectancy of the equipment is thus increased, and the energy efficiency of the equipment is improved. Further, as the regulator does not require complex electronic parts, it can be manufactured relatively cheaply. As the regulator is a separate element from the heating cable it is easy to retrofit to existing heating installations. Further, the cost of the heating cable system including the controls package will be reduced as the control package has been simplified

The device may comprise a voltage source arranged to apply voltage across the heater and the heater regulator, with the heater regulator being connected electrically in series between the heating cable and the voltage source.

The heater regulator may consist of the material having a positive temperature coefficient of resistance.

The heater regulator may comprise a length of the material having a substantially uniform resistance per unit length.

The material having a positive temperature coefficient of resistance may be formed as a cable of polymeric material.

The electrical resistance of the heating cable may be substantially independent of temperature over the typical operating temperature range of the heating cable.

The heater regulator may be in thermal contact with a predetermined temperature source.

The heating cable may be arranged to heat an object, and the temperature source may be the ambient environment around the object.

The heating cable may be arranged to heat an object, and the object may be the temperature source.

The heating cable may be arranged to supply heat to a conduit, such that fluid flowing within the conduit is heated.

The heating cable assembly may comprise a cold start limiter element comprising a material having a negative temperature coefficient of resistance, for connection electrically in series with the voltage source, the heater regulator and the heating cable.

The cold start limiter element may be in thermal contact with at least one of the heater regulator and the heating cable.

The negative temperature coefficient of resistance may be greater below a predetermined minimum temperature, such that the limiter element limits the current flowing through the heating cable when the temperature of said heating cable is below a normal operating temperature.

According to a second aspect, the present invention provides a method of providing a heating cable assembly comprising: connecting a heater regulator in electrical series with a heating cable; and connecting a voltage source across the heating cable and the heater regulator; wherein the heater regulator comprises a material having a positive temperature coefficient of resistance, such that the voltage across the heating cable is dependent upon the temperature of the heater regulator.

The heater regulator may be formed by cutting a predetermined length of material from a longer length of material having a substantially constant resistance per unit length and a positive temperature coefficient of resistance, such that at a predetermined maximum temperature the resistance of the predetermined length of material is a predetermined value.

According to a third aspect, the present invention provides a temperature dependent voltage supply for supplying power to a heating cable may comprise: a regulator element having a positive temperature coefficient; and a voltage source for connection in electrical series with the regulator element and the heating cable.

The voltage supply may further comprise a cold start limiter element comprising a material having a negative temperature coefficient of resistance.

According to a fourth aspect, the present invention provides a heating cable assembly comprising a heating cable having a resistive heating element; a material having a positive temperature coefficient resistance for controlling the heat output from the heating cable; and a cold start limiter element comprising a material having a negative temperature coefficient of resistance for connection electrically in series with the heating element and a voltage source.

By utilising a material having a negative temperature coefficient of resistance, the in-rush current of the heating cable assembly can be reduced. This reduces the power drawn by the heating cable assembly on start-up. This also reduces the risk of damage to the heating cable upon start-up.

The material having a positive temperature coefficient of resistance may be formed as an integral part of the heating cable.

The heating cable may be a parallel resistance heating cable.

The parallel resistance heating cable may comprise two conductors extending along the length of the cable, with the material having the negative temperature coefficient of resistance being formed around one of said conductors.

According to a fifth aspect, the present invention provides a method of providing a heating cable assembly comprising providing a cold start limiter element comprising material having a negative temperature coefficient of resistance, coupled in series with a resistive heating element.

According to a sixth aspect, the present invention provides a parallel resistance heating cable comprising two conductors extending adjacent to one another, a heating element comprising a positive temperature coefficient of resistance material provided between the two conductors; and a cold start limiter element comprising a material having a negative temperature coefficient of resistance formed around one of the two conductors.

A material having a different positive temperature coefficient of resistance may be formed around one of the two conductors. The material having a different positive temperature coefficient may comprise a positive temperature coefficient switch material.

Further objects and advantages of embodiments of the present invention will be readily apparent from the following description.

Embodiments of the present invention will now be described, by way of example only, with reference to the accompanying drawings in which:

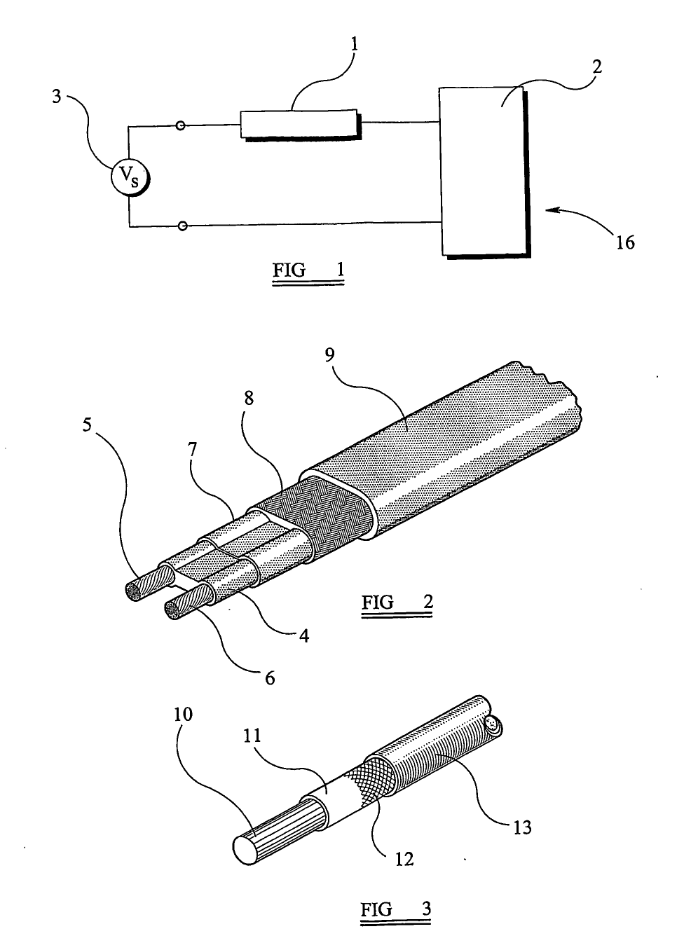

FIG. 1 is a schematic diagram of a heating assembly in accordance with a first embodiment of the present invention;

FIG. 2 is a perspective view of a parallel resistance heating cable;

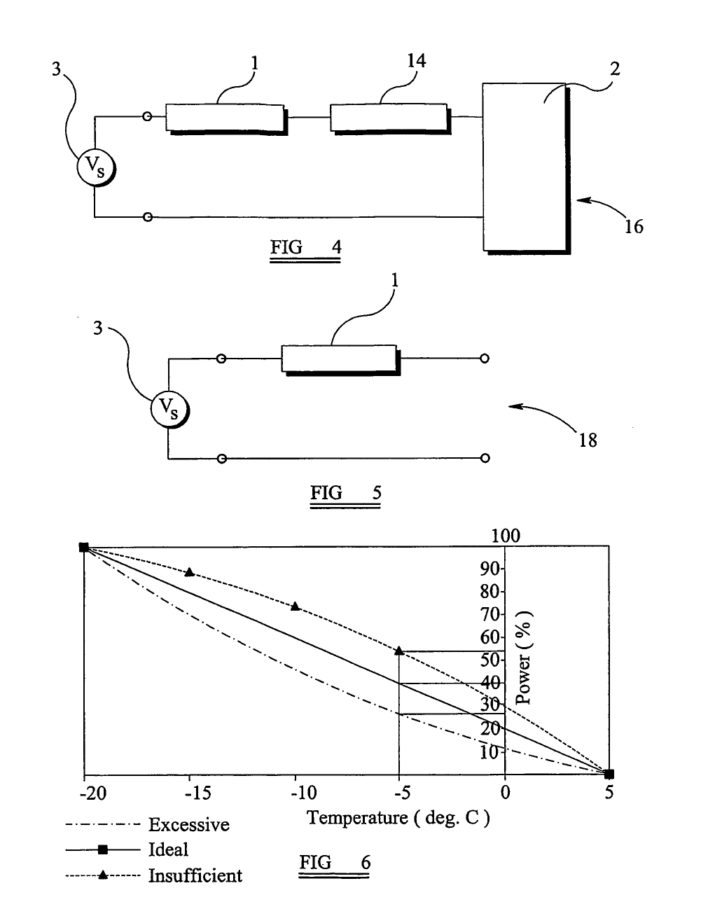

FIG. 3 is a perspective view of a series resistance heating cable;

FIG. 4 is a schematic diagram of a heating assembly in accordance with a second embodiment of the present invention;

FIG. 5 is a schematic diagram of a temperature dependent voltage supply in accordance with the third embodiment of the present invention;

FIG. 6 is a graph indicating the power output of a heating assembly in accordance with the first embodiment of the present invention, as a function of temperature;

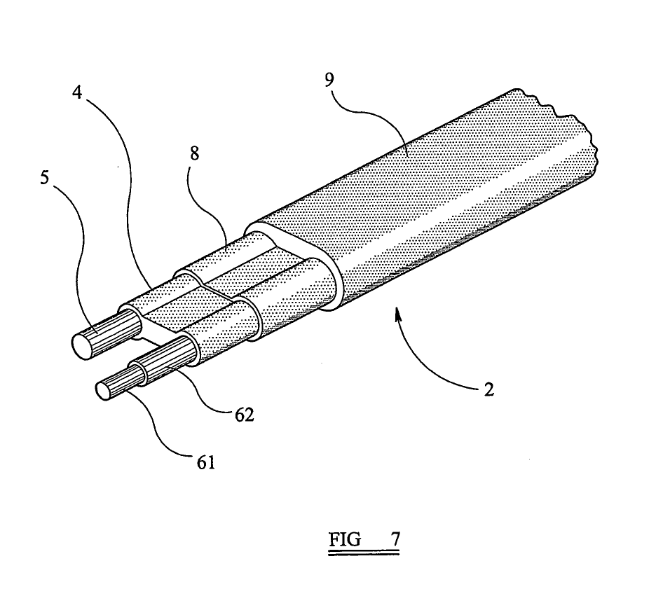

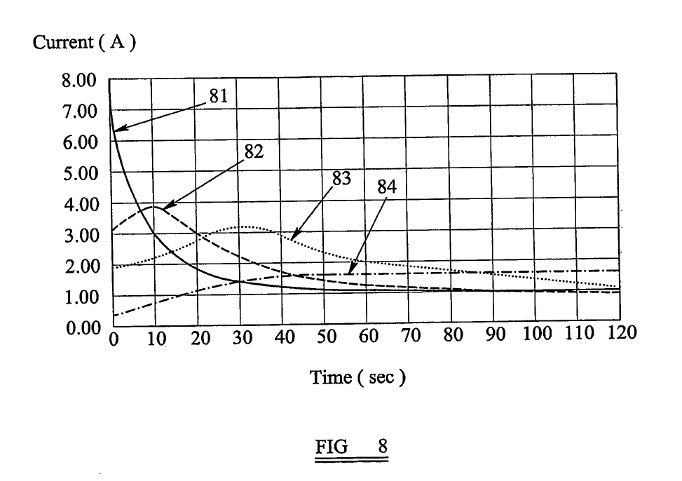

FIG. 7 is a heating cable in accordance with a further embodiment of the present invention; and

FIG. 8 is a graph indicating the current as a function of time at start-up through the heating cable illustrated in FIG. 7.

FIG. 1 shows a schematic diagram of a heating device 16 in accordance with the first embodiment of the present invention. The device 16 comprises a heater regulator 1, a heating cable 2 and a voltage source 3.

The heater regulator, also termed a regulator element 1, is connected electrically in series with a heating cable 2. A voltage source 3 is arranged to apply a voltage across the heating cable 2 and the regulator element 1. The regulator element 1 has a positive temperature coefficient of resistance. Consequently, as the temperature of the regulator element 1 increases the resistance of the regulator element 1 increases. The voltage supplied by voltage source 3 is substantially constant, therefore as the resistance of the regulator element 1 increases the voltage across regulator element 1 increases. The heating cable 2 typically has a resistance, which is substantially independent of temperature over the operating range of the cable in normal conditions. These normal conditions may include or exclude the start-up condition of the cable. Consequently, as the temperature at regulator element 1 increases, the electrical power supplied to the heater 2 is reduced. This decreases the power dissipated by heater 2. This results in a reduction of the heat generated by heating cable 2.

The heating cable 2 is typically used to form the heating part of a heated fluid conduit. The electrical heating cable 2 may be any form of trace heating cable e.g. it may be a series or a parallel resistive heating cable, such as those shown in FIGS. 2 and 3.

Referring now to FIG. 2 this shows a first known form of semi-conductive heating cable 2. The cable consists of a semi-conductive polymeric matrix 4, extruded around two parallel conductors 5 and 6. The matrix 4 serves as a heating element. A polymeric insulator jacket 7 is then extruded over the matrix 4. Typically, a conductive braid 8 (e.g. a tinned copper braid) is added for additional mechanical protection and/or use as an earth wire. Such a braid is typically covered by a thermoplastic over jacket 9 for additional mechanical and corrosive protection.

The cable thus has a parallel resistance form, with power being supplied via the two conductors to the heating element, connected in parallel across the two conductors. In use, a voltage is applied across the two conductors. Other types of parallel resistance heating cable are also known.

An alternative form of semi-conductive heating cable 2 is illustrated in FIG. 3. The heating cable 2 comprises a resistive heating element 10, extending longitudinally throughout the cable. The element may comprise a semi-conductive material such as a wire or string or may comprise any other electrically resistive material. A primary insulation jacket or coating 11 surrounds the heating element 10. This is used to electrically insulate the element 10 from the surroundings. A conductive outer braid 12 (e.g. copper braid) can optionally be added for additional mechanical protection and/or use as an earth wire. Such a braid 12, may also be covered by a thermoplastic outer jacket 13 for additional mechanical protection. Such a cable is termed a series resistive heating cable. In use, a voltage is applied along the cable length e.g. by coupling the two ends of the heating element to a voltage source.

The regulator element 1 may comprise a length of material having a substantially constant or uniform resistance per unit length at a predetermined temperature. Therefore, for a given length of such material, the resistance is proportional to the temperature of the regulator element.

In order to form the regulator element, a maximum ambient temperature is determined. The maximum ambient temperature will depend upon the location of the regulator element 1 when in use. For instance, if the heater element 1 is placed in thermal contact with a surface of the heating cable 2, then the maximum ambient temperature is chosen to correspond to the maximum operating temperature of the surface of the heating cable. Alternatively, if, in use, the regulator element 1 is arranged to be located a slight distance away from the heating cable 2, then the maximum ambient temperature selected will correspond to the temperature detected by the regulator when the cable is operating at, or close to, the maximum desired operating temperature.

A length of positive temperature coefficient material is cut to form regulator element 1. Such material could, for instance, be a polymeric matrix, of the same type of material used to form self-regulating heating cable. The length is chosen such that at the predetermined maximum temperature the resistance of the regulator element 1 is at a predetermined maximum resistance. This predetermined maximum resistance is chosen to be (significantly) greater than the resistance of the heater element e.g. by an order of magnitude, or even two orders of magnitude, or more. Consequently as the temperature of the regulator 1 rises up to or above the predetermined maximum temperature, the majority of the voltage supplied by voltage source 3 is dissipated within the regulator 1 such that the power supply to the heating cable 2 is reduced. The heat output of the heating cable 2 is consequently reduced. As the temperature of the regulator 1 reduces, less of the voltage supplied by voltage source 3 is dissipated within regulator 1. This results in the power supply to the heating cable 2 being increased. The heat generated by heating cable 2 thus increases.

The regulator element 1 can take any number of forms. In the simplest instance, it will consist only of a piece (e.g. a length) of material having a positive temperature coefficient of resistance. However, it may have a more complex structure, comprising a plurality of lengths of different materials of different properties connected in series or in parallel to obtain the desired resistance variation with respect to temperature. Preferably, the material is formed as a semi-conductive material shaped as a wire or string. One example of a suitable material is semi-conductive high-density polyethylene (HDPE), such as carbon-loaded polyethylene. Typically, the element will have a substantially circular cross-section, of diameter 2 mm. Typically, the element will be formed by extrusion.

The positive temperature coefficient material of the regulator 1 may be surrounded by a number of other elements or structures e.g. protective coating(s) to prevent damage to the material and/or electrically insulate the material. For instance, the regulator could take the form of the heating cable illustrated in FIG. 3, but with the heating element 10 being formed of the material having a positive temperature coefficient. Electrical connection would be made to both ends of the cable.

Alternatively, the regulator could take the form of the heating cable shown in FIG. 2, but with the heating element 4 being formed of positive temperature coefficient material. In use, an electrical connection would be made to each conductor 5, 6 e.g. conductor 5 connected to the voltage source, and conductor 6 to the heater. Thus the regulator element would be in electrical series with the heater and voltage source, even though the positive temperature coefficient of material would be effectively connected in parallel between the two conductors 5, 6.

The regulator 1 is located to sense either the ambient temperature surrounding the heated conduit or the temperature of the heated conduit. If the regulator 1 is positioned to sense the ambient temperature surrounding the heated conduit then this is particularly suitable for providing freeze protection for pipes carrying fluids. Alternatively, if the regulator element 1 is connected to sense the temperature of the heating cable 2 (or the heater element of the heating cable 2), which forms part of the heated conduit, then this is suitable for ensuring that the temperature of the heater element does not exceed a safe level.

FIG. 6 illustrates the operation of the heating assembly illustrated in FIG. 1. In this particular embodiment, the heating cable is designed to operate over an ambient air temperature of between −20° C. and +5° C. The power output of the heating cable is indicated as a function of the ambient air temperature surrounding the heating cable. Three different scenarios are indicated, corresponding to three different types of temperature regulator. In the ideal scenario, the power output of the heating cable is linear as a function of the air temperature. Such a situation is, for instance, suitable for use in heating cable installations to protect pipes from freezing. Typically, the type of positive temperature coefficient of resistance material, and the dimension (e.g. length, and cross section) of the heater regulator 1 will be selected to give the ideal, linear power output response. If the power output curve has a convex shape then excessive power is applied resulting in wasted energy. On the other hand if the power output curve has a concave shape then not enough power is applied and the set temperature (i.e. the temperature at which it is desirable to maintain, to provide the desired heating performance) will not be maintained.

FIG. 4 illustrates a further embodiment of a heating device 16. The regulator element 1 comprises a material having a positive temperature coefficient connected electrically in series with the heating cable 2. Additionally, in electrical series with the regulator element 1 and heating cable 2 is a cold start limiter element 14. The cold start limiter element 14 has a negative temperature coefficient. The voltage source 3 is arranged in series, so as to apply a voltage across both elements and the heating cable.

As the temperature falls the resistance of the cold start limiter element 14 increases. Consequently, as the temperature of the cold start limiter element 14 falls, the power dissipated by the cold start limiter element 14 is increased. The effect of this is to reduce the power supply to the heating cable 2.

The material for the cold start limiter element 14 is chosen such that the negative temperature coefficient increases in magnitude below a predetermined minimum temperature. This limits the current flowing through the heating cable when the temperature of the cold start limiter element 14 is at or below the minimum temperature. This is desirable as without the cold start limiter element 14 at very low temperatures the resistance of the regulator element 1 will be very low. This can result in the dangerously high current being supplied to the heating cable 2 when the cable is turned on during cold spells.

The minimum temperature may correspond to the lowest normal operating temperature of the cable. For instance, if the cold start limiter element 14 is only indirectly thermally coupled to the cable, then the minimum temperature may correspond to the temperature to which the element 14 would be heated, when the cable is operating at (or slightly below) the lowest normal operating temperature for that particular application.

The physical structure of the cold start limiter element 14 may typically be similar to the regulator element 1. However, to form cold start limiter element 14 the material forming the semi-conductive polymeric matrix is chosen to have a negative temperature coefficient.

In normal operation the cold start limiter element 14 will typically be arranged to be in thermal contact with the regulator element 1. In combination, the power supplied to the heating cable 2 is such that at, or below, a minimum predetermined temperature the power supplied will be low due to the relatively high resistance of the element 14. The power supplied to the heating cable 2 will increase rapidly around the minimum temperature and then decrease approximately linearly, until the temperature reaches the predetermined maximum temperature. The effect of this is that at low temperatures the heating cable 2 is operating near its maximum heat output and at higher temperatures the heat output is reduced. Further, the heater element is protected from physical damage due to high current flow at very low temperatures.

FIG. 7 shows an alternative heating cable assembly. The heating cable assembly generally has similar features to those indicated in the heating cable shown in FIG. 2, with identical reference numerals being utilized to illustrate similar features. In this particular embodiment indicated in FIG. 7, two conductors 5, 61 extend in parallel along the cable. A polymeric matrix 4 with a positive temperature coefficient of resistance is provided between the conductors 5, 61. Further, at least one (and possibly both) of the conductors 5, 61 extending longitudinally along the cable is coated with a material 62 having a negative temperature coefficient of resistance. In this embodiment only one of the conductors (61) is coated with such a material (62). Such a material thus acts to provide the cold start limiter element, in a manner similar to that described above. In effect, the negative coefficient of resistance material 62 is in electrical series with the positive temperature coefficient of resistance matrix 4. Thus, the negative temperature coefficient of resistance material will limit the in-rush current on start-up. The term ‘coated’ as used above should not be interpreted as limiting the manner in which the negative temperature coefficient of resistance material 62 is provided around the conductor 61.

An advantage of the cable illustrated in FIG. 7 is that, since the positive temperature coefficient of resistance material 4 is provided as part of the heating cable, the amount of material automatically corresponds to the length of the heating cable. This means that the operation of the positive temperature coefficient of resistance material as a regulator is automatically adjusted with the length of the cable. This is more straightforward than the arrangement described further above, where the regulator 1 is separate from the heating cable and the amount of positive temperature coefficient material in the regulator is selected for a particular length of heating cable.

Similarly, the negative temperature coefficient of resistance material 62 is provided as part of the heating cable, and the amount of material automatically corresponds to the length of the heating cable.

The conductor 5 which is not coated with negative temperature coefficient material may be coated with a positive temperature coefficient material. This material for clarity is referred to here as the second positive temperature coefficient material. The positive temperature coefficient material 4 referred to above is referred to as the first positive temperature coefficient material 4. The second positive temperature coefficient material has a different coefficient than the first positive temperature coefficient material 4. For example the second positive temperature coefficient material may have a high gradient above a particular temperature, such that the heating cable is effectively switched off if it becomes hotter than that temperature. A material of this type may be referred to as a positive temperature coefficient switch material.

FIG. 8 illustrates different in-rush currents through a heating cable assembly incorporating a material having a positive temperature coefficient of resistance e.g. the heating cable illustrated in FIG. 4 or in FIG. 7. The current through the heater element of the heating cable is illustrated as a function of time. Four different current trends 81-84 are illustrated. The first trend line 81 represents the standard operation that occurs with heating cable that is controlled in a conventional way. In this system there is no cold start limiter element present. It will be observed that the current at start-up is approximately 7 times greater than the current during normal, steady state operation of the heating cable (e.g. after a time period of around 1-2 minutes). This would be the typical response of a self-regulating type of heater. The subsequent graphs illustrate the effect on reducing the peak in-rush current by a predetermined amount (e.g. 82: reducing the peak in-rush current to 4 times that of the normal steady state operating current, then 83: reducing to 3 times, and finally 84: the in-rush current is lower that the normal steady state current. Such reductions are provided by incorporating different cold start limiter elements (e.g. formed of materials having different negative temperature coefficients of resistance) within the heating cable assembly. The different reductions in in-rush current correspond to utilizing different materials having different negative temperature coefficient characteristics and/or the elements 14 having different dimensions. Typically, the NTC component will be selected such that the heating element reaches a steady state drawing of current within a time scale of between 0.5 and 5 minutes, and more preferably between 1 and 3 minutes.

FIG. 5 illustrates a temperature dependent voltage supply 18 for supplying power to a load, such as a heating cable. Voltage source 3 supplies a voltage to a regulator element 1 connected to one of its terminals. A load may be connected between the end of the regulator element not connected to the voltage supply 3 and the second terminal of the voltage supply 3. This load may be a heater element, or it may be any form of electrical device, which requires the power to be decreased as temperature rises and vice versa. Additionally, a cold start limiter element 14 may be incorporated in series with the regulator element 1 to form part of the temperature dependent voltage supply. This is not illustrated in FIG. 5.

A temperature dependent heating device as described above may be installed by the following steps. Firstly, obtaining a length of semi-conductive material having a positive temperature coefficient for use as the regulator element, and cutting a required length from this cable. The length to be cut may be determined by choosing a maximum temperature, and calculating the required resistance for the element to have at that temperature, in combination with determining the size of the voltage source. This length of cable is then connected electrically in series with a heater element, or any other load to be temperature controlled. The voltage source is then connected across the cable and the heater element or other load.

It will be readily apparent to the appropriately skilled person that such a voltage source is suitable for supplying power to any form of electrical system in which the power supplied must be dependent upon a sensed temperature. This temperature may be either the temperature of the load (e.g. heating cable) being supplied, or alternatively an ambient temperature source, or any other temperature source. The exact relationship between temperature and power supplied may be chosen by appropriate selection of, the material(s) forming the regulator element (i.e. to select the desired ranges of temperature coefficient of resistance) of and the length(s) of materials used. Additionally, further control elements such as further temperature dependent elements, or other known control elements such as thermostats may be incorporated. The temperature coefficient may vary over the temperature range. The temperature coefficients of the various elements, in combination, may result in the device having an overall positive, negative, or neutral temperature coefficient at different temperatures.

Further, it will be readily apparent to the appropriately skilled person that the heater element may not in fact have a constant resistance. The resistance of the heater element may itself be dependent upon the temperature. Additional control elements may also be included for controlling the power supply to the heating cable, or other load, dependent upon other environmental conditions. These may include monitoring ambient humidity, light or any other environmental factor.

Further modifications, and applications, of the present invention will be readily apparent to the appropriately skilled person, without departing from the scope of the appended claims.

1. A heating cable assembly comprising:
a heating cable;
a heater regulator for connection electrically in series between the heating cable and a voltage source;
wherein the heater regulator comprises a material having a positive temperature coefficient of resistance such that in use the voltage across the heating cable is dependent upon the temperature of the heater regulator.

2. A heating cable assembly according to claim 1, further comprising a voltage source arranged to apply voltage across the heater and the heater regulator, with the heater regulator being connected electrically in series between the heating cable and the voltage source.

3. A heating cable assembly according to claim 1, wherein the heater regulator consists of the material having a positive temperature coefficient of resistance.

4. A heating cable assembly according to claim 1, wherein the heater regulator comprises a length of the material having a substantially uniform resistance per unit length.

5. A heating cable assembly according to claim 1, wherein the material having a positive temperature coefficient of resistance is formed as a cable of polymeric material.

6. A heating cable assembly according to claim 1, wherein the electrical resistance of the heating cable is substantially independent of temperature over the typical operating temperature range of the heating cable.

7. A heating cable assembly according to claim 1, wherein the heater regulator is in thermal contact with a predetermined temperature source.

8. A heating cable assembly according to claim 7, wherein the heating cable is arranged to heat an object, and the temperature source is the ambient environment around the object.

9. A heating cable assembly according to claim 7, wherein the heating cable is arranged to heat an object, and the object is the temperature source.

10. A heating cable assembly according to claim 1, wherein the heating cable is arranged to supply heat to a conduit, such that fluid flowing within the conduit is heated.

11. A heating cable assembly according to claim 1, further comprising a cold start limiter element comprising a material having a negative temperature coefficient of resistance, for connection electrically in series with the voltage source, the heater regulator and the heating cable.

12. A heating cable assembly according to claim 11, wherein the cold start limiter element is in thermal contact with at least one of the heater regulator and the heating cable.

13. A heating cable assembly according to claim 11, wherein the negative temperature coefficient of resistance is greater below a predetermined minimum temperature, such that the limiter element limits the current flowing through the heating cable when the temperature of said heating cable is below a normal operating temperature.

14. A method of providing a heating cable assembly comprising:
connecting a heater regulator in electrical series with a heating cable; and
connecting a voltage source across the heating cable and the heater regulator, wherein the heater regulator comprises a material having a positive temperature coefficient of resistance, such that the voltage across the heating cable is dependent upon the temperature of the heater regulator.

15. A method according to claim 14, further comprising the step of forming the heater regulator by cutting a predetermined length of material from a longer length of material having a substantially constant resistance per unit length and a positive temperature coefficient of resistance, such that at a predetermined maximum temperature the resistance of the predetermined length of material is a predetermined value.

16. A temperature dependent voltage supply for supplying power to a heating cable comprising:
a regulator element having a positive temperature coefficient; and a voltage source for connection in electrical series with the regulator element and the heating cable.

17. A voltage supply as claimed in claim 16, further comprising a cold start limiter element comprising a material having a negative temperature coefficient of resistance.

18. A parallel resistance heating cable comprising two conductors extending adjacent to one another, a heating element comprising a positive temperature coefficient of resistance material provided between the two conductors; and a cold start limiter element comprising a material having a negative temperature coefficient of resistance formed around one of the two conductors.

19. A heating cable as claimed in claim 18, wherein a material having a different positive temperature coefficient of resistance is formed around one of the two conductors.

20. A heating cable as claimed in claim 19, wherein the material having a different positive temperature coefficient comprises a positive temperature coefficient switch material.
